(19) United States
(12) Patent Application Publication
(10) Pub. No.: US 2026/0238661 A1
(43) Pub. Date: Aug. 13, 2026

(54) METHOD AND A SERVER FOR RESPONDING TO CYBERTHREATS

(71) Applicant: GROUP-IB GLOBAL PRIVATE LIMITED, SINGAPORE (SG)

(72) Inventor: Dmitry VOLKOV, Abu Dhabi (AE)

(21) Appl. No.: 19/055,914

(22) Filed: Feb. 18, 2025

(30) Foreign Application Priority Data
Feb. 11, 2025 (SG) 10202500377Y

(51) Int. Cl. H04L 9/40; G06N 3/09

(52) U.S. Cl. CPC H04L 63/1425; G06N 3/09; H04L 63/1441

(57) ABSTRACT

Method and a server for determining a response to cyberthreats are provided. The method comprises: training a neural network to identify false-positive alert messages by: generating a cyberthreat database, the generating including acquiring, from a plurality of cyber-intelligence sources, data associated with a plurality of cyberthreats; acquiring a plurality of training alert messages generated by information security systems, using internal alert data and host data associated with a given training alert message to query the cyberthreat database to identify enrichment data associated with the given training alert message; generating a respective vector for the given training alert message using: (i) the internal alert data; (ii) the host data; (iii) the enrichment data of the given training alert message; and (iv) a respective label thereof; and feeding the respective vector to the neural network to train the neural network to determine whether a given in-use alert message is false-positive.

### CROSS-REFERENCE TO RELATED APPLICATIONS

The present patent application claims priority from Singapore Patent Application No. 10202500377Y filed on Feb. 11, 2025, an entirety of contents of which is incorporated herein by reference.

### FIELD

The present technology relates broadly to the field of cybersecurity; and, in particular, to methods and systems for responding to cyberthreats.

### BACKGROUND

Intensive development of cybersecurity tools is balanced by introduction of various information security systems intended to monitor statuses of network infrastructures (such as a wide area network (WAN) of a given enterprise or local area networks (LANs)) to identify and detect malicious software and vulnerabilities of a given infrastructure to be protected.

However, it should be noted that despite the variety of such systems, their general operation principles remain the same. The system monitors states of certain parameters of network devices of the infrastructure to be protected (servers, working stations, routers, etc.), states of certificates installed thereon, ports and services launched on these ports, analyzes traffic, including messages from messengers and emails, monitors a behavior and parameters of user accounts, as well as statuses and parameters of computing devices that are coupled to the infrastructure, including DNS servers, external recipients of the traffic, etc. Upon detection of events that may indicate a potential cyberthreat to the infrastructure to be protected, the system will provide warnings (also referred to herein as “alert messages” or “alerts” for short).

The alert is a message that is displayed on a user interface of a respective information security system and/or sent by the system via one or more suitable communication channels. This message may include a name of the potential threat, a hazard level assigned thereto, an IP address and a domain name of the computing device with which the threat is associated, a hyperlink; a name, a textual description and a content of a triggered signature, a piece of data which this signature has been triggered on, and other information.

Since their very introduction to the market, almost all such systems have had a problem of generating false positive alert messages. The false positive alert is a alert that looks like a reliable message about a cyberthreat, however, generated in response to a benign event. A number of false positive alerts tends to increase with increase of a number of information security systems, and nowadays this problem is still pertinent.

Certain prior art approaches have been proposed to address the identified technical problem.

A commonly used approach to resolve this problem is to check incoming alerts whether they are reliable or not, which is usually implemented by identifying other alerts that correlate with the generation of a given incoming alert. There are attempts to perform these actions automatically; for example, the search for the correlating alerts can be performed by some modern information security systems such as an Extended Detection and Response (XDR) system or a Security Information and Event Management (SIEM) system.

Also, an article entitled “AI-Assisted Security Alert Data Analysis with Imbalanced Learning Methods,” authored by Ndichu et al., and published on Feb. 3, 2023 in Cybersecurity Research Institute, National Institute of Information and Communications Technology, Tokyo 184-8795, Japan, discloses a two-way approach to resolve a problem of imbalance of classes during automated analysis of alerts. This method utilizes a set of three processes for sorting in order to create an advanced set of high-quality synthetic positive samples and applies the data subsampling algorithm to detect and remove noisy negative samples.

U.S. Pat. No.: 11,785040-B2, issued on Oct. 10, 2023, assigned to Capital One Services LLC, and entitled “SYSTEMS AND METHODS FOR CYBER SECURITY ALERT TRIAGE,” discloses systems, apparatuses, and methods for mitigating cyber-attacks. For example, the method includes receiving, from one or more network devices tracking activity on a network, one or more data streams associated with a respective one of the one or more network devices, identifying a security alert from the one or more data streams, the security alert including metadata context describing the network device from the one or more network devices that originated the security alert, analyzing the metadata context to generate a metadata context score. When the security alert is determined to be a security threat event, classifying a type of the security threat event based on the related activity score and the metadata context, and outputting a recommended mitigation course of action based on the classified type of the security threat event.

United States Patent Application Publication No: 2022/0159,034-A1, published on May 19, 2022, assigned to FACCT Network Security LLC, and entitled “METHOD AND SYSTEM FOR DETERMINING AN AUTOMATED INCIDENT RESPONSE,” discloses a method and a system of responding to a cybersecurity incident are disclosed. The method comprises: receiving incident data of at least one incident targeting a given computer system; analyzing the incident data of the at least one incident, including determining whether the at least one incident has been prevented before; in response to determining that the at least one incident has not been prevented yet in the given computer system, determining, based on the incident data, a threat severity of the at least one incident; and in response to the threat severity of the at least one incident exceeding a predetermined threat severity threshold, determining, based on the incident data, one or more responses to the at least one incident for responding thereto in the given computer system

### SUMMARY

It is an object of the present technology to ameliorate at least some inconveniences associated with the prior art.

The prior art solutions reviewed above use only limited data from the alerts themselves for determining whether the given alert is false-positive, which may lead to inaccurate results. Although some of the above-reviewed approaches are directed to enriching input data by data on relationships between malicious software programs and servers, as well as data about tactics and methodologies of known cybercrime groups, these prior-art approaches do not utilize any cyber-intelligence data and telemetry of the information security systems.

Thus, the developers of the present technology have devised methods and systems that aim to automate the analysis, sorting, search and filtration of the alerts, as well as making decisions about possible cybersecurity threats based on a complex analysis of the entire set of information associated with each particular alert. The disclosed methods and systems, in at least some non-limiting embodiments of the present technology thereof, are believed to be free of drawbacks that are peculiar to manual labor used in the prior art, and therefore have a higher running speed, require no long-term and expensive deployment, while ensuring a higher accuracy of determining false positive alerts as compared to all currently known approaches.

More specifically, in accordance with a first broad aspect of the present technology, there is provided a computer-implemented method for determining a response to cyberthreats. The method comprises, during a first phase, training, on a server, a neural network to identify false-positive alert messages of information security systems. The training comprises: generating a cyberthreat database, the generating including acquiring, from a plurality of cyber-intelligence sources, data associated with a plurality of cyberthreats, the data, for a given cyberthreat of the plurality cyberthreats, including one or more selected from the group consisting of: a type of the given cyberthreat, one or more actor executing the given cyberthreat, means of executing the given cyberthreat, and indicators of compromise associated with the execution of the given cyberthreat; acquiring a plurality of training alert messages generated by information security systems, a given training alert message of the plurality of training alert messages being assigned with a respective label representative of whether the given training alert message is one of (i) an alert message that has been generated in response to an actual cyberthreat; and (ii) a false-positive alert message that has been generated without an influence of the actual cyberthreat; the given training alert message being associated with: (i) internal alert data extracted from the given training alert message; and (ii) host data of the given alert message, including data of a respective host having triggered generation of the given training alert message; using the internal alert data and the host data associated with the given training alert message to query an Internet graph model to identify additional data for the given training alert message; using the internal alert data, the host data, and the additional data associated with the given training alert message to query the cyberthreat database to identify enrichment data associated with the given training alert message; generating a respective vector for the given training alert message using: (i) the internal alert data; (ii) the host data; (iii) the additional data; (iv) the enrichment data associated with the given training alert message; and (iv) the respective label thereof; feeding the respective vector associated with the given alert message to the neural network, thereby causing the neural network to generate an intermediate prediction of whether a given in-use alert message is false-positive; optimizing a difference between the intermediate prediction and the respective label associated with the given training alert message, thereby training the neural network to determine whether the given in-use alert message is false-positive. Further, during a second phase, following the first phase, in response to receiving, by a computing device, communicatively coupled to the server, at least one in-use alert message from a respective information security system, the method comprises: retrieving, on the computing device, in-use host data and in-use internal alert data associated with the at least one in-use alert message; using the in-use internal alert data and the in-use host data to query the Internet graph model to identify in-use additional data for the at least one in-use alert message; using the in-use internal alert data, the in-use host data, and the in-use additional data associated with the at least one in-use alert message to query the cyberthreat database to identify in-use enrichment data associated with the at least one in-use alert message; generating a respective in-use vector for the at least one in-use alert message using: (i) the in-use internal alert data; (ii) the in-use host data; (iii) the in-use additional data; and (iv) the in-use enrichment data associated with the at least one in-use alert message; feeding the respective in-use vector to the trained neural network to generate a likelihood value of the at least one in-use alert message being a false-positive alert message; in response to the likelihood value being lower than a predetermined threshold value, causing the computing device to: identify the at least one in-use alert message as being generated in response to a respective actual cyberthreat; and respond to the respective actual cyberthreat; and in response to the likelihood value being equal to or greater than the predetermined threshold value, causing the computing device to identify the at least one in-use alert message as being a false-positive alert message in the respective information security system.

In some implementations of the method, the information security systems include one or more selected from the group consisting of: an Intrusion Detection System (IDS) system; a Next-Generation Firewall (NGFW) system; an Endpoint Detection and Response (EDR) system; a Web Application Firewall (WAF) system; a Security Information and Event Management (SIEM) system; an Extended Detection and Response (XDR) system; an External Attack Surface Management (EASM) system; an Identity and Access Management (IAM) system; a Unified Threat Management (UTM) system; a Cloud Access Security Broker (CASB) system; a Cloud-Native Application Protection (CNAP) system; a Cloud Security Posture Management (CSPM) system; a Cloud Infrastructure Entitlement Management (CIEM) system; a Cloud Workload Protection Platform (CWPP) system; a monitoring system; and a visualization system.

In some implementations of the method, the causing the computing device to respond to the respective actual cyberthreat includes executing at least one selected from the group consisting of: causing the computing device to end a process associated with the respective actual cyberthreat; isolating the computing device; generating a memory dump of the computing device; sending a warning notification comprising the at least one selected from the group consisting of in-use alert, the threat data, and the additional data to an operator of the respective information security system; escalating responding to the respective actual cyberthreat; restoring an operating system of the computing device to its initial state before the respective actual cyberthreat; and adding, to a block list, a result of taking a hash function from a malicious file, a domain name, a URI, a URL, and an IP address, associated with the respective actual cyberthreat.

In some implementations of the method, the sending the warning notification is executed by at least one selected from the group consisting of: sending an email; sending a text message; sending a media messaging service (MMS) message; sending a push notification; sending messages in an instant messaging program; and sending API events.

In some implementations of the method, the plurality of cyber-intelligence sources includes at least selected from the group consisting of: open-source intelligence (OSINT); analyzing closed forums; structured data flows about malicious software, using Malware feeds; structured data flows about indicators of compromise, using IoC feeds; reports of analytical online services; vulnerability lists, using Common Vulnerability and Exposure (CVE); lists of intruders and cybercrime groups; lists of tactics, methodologies, and procedures used by the cybercrime groups and intruders; program source code repositories; repositories of exploits; repositories of templates of malicious websites and phishing kits; configuration files of the malicious software; results of reverse engineering of the malicious software; websites that provide services for exchange of hyperlinks; websites that provide services for publishing source code texts of the programs; databases of domains, IP addresses, and links used for phishing and other fraudulent activities; honeypots; virtual machines; scanners of IP addresses; crawlers; and telemetry of the information security systems.

In some implementations of the method, the respective label is further representative of whether the given training alert message includes at least one selected from the group consisting of network interaction data and files data.

In some implementations of the method, the host data of the respective host associated with the given training alert message comprises at least one selected from the group consisting of: a name of the respective host within an infrastructure to be protected where the given training alert message has been generated; user accounts that are present at the respective host; privilege levels of each of the user accounts: guest, user, administrator; an organizational and staff structure associated with the name of the respective host; an organizational and staff structure of each users associated with the respective host; a local network domain associated with each user that is associated with the respective host; a technical configuration of the respective host, including one selected from the group consisting of: a server, a desktop computer, a notebook, a tablet, a smartphone, a video camera, a multifunctional device, and a printer; other alert messages having been generated in the respective host.

In some implementations of the method, the internal alert data of the given training alert message includes at least one selected from the group consisting of: a name of a potential cyberthreat associated with the given training alert message; a hazard level of the potential cyberthreat; an IP address of a server associated with the potential cyberthreat; a domain name associated with the potential cyberthreat; a hyperlink associated with the potential cyberthreat; a result of taking a hash function from a potentially malicious file associated with the potential cyberthreat; and a name of a signature that detected the potential cyberthreat.

In some implementations of the method, the additional data comprises at least one selected from the group consisting of: a name of an ownership company of an IP address of a server associated with a potential cyberthreat having triggered the given training alert message; a hosting provider of the IP address; a validity period of the IP address; a list of ports that are open at this IP address; a list of network services launched at this IP address; a hash function of a sum of configurations of each of the list of network services; types, names, and versions of programs installed on the computing device located at the IP address; a tag that is a name of a cybercrime group or a malicious software; a name of an ownership company of a domain associated with a potential cyberthreat; a domain registrar of the domain; a domain validity period of the domain; a status of an SSL-or a TLS-certificate of the domain; parameters of the SSL-or TLS-certificate, including encryption algorithms that may be used by a server, where the SSL-or TSL certificates are installed; and a validity period of the SSL-or TLS-certificate.

In some implementations of the method, the method further comprises filtering the additional data by dates associated with the given training alert message.

In some implementations of the method, the enrichment data comprises at least one selected from the group consisting of: a name of malicious software associated with the given training alert message; a name of a cybercrime group associated with the given training alert message; a vulnerability designation value according to a Common Vulnerability and Exposure (CVE) system, associated with the given training alert message; a compromise indicator associated with the given training alert message; an IP address associated with the given training alert message; and a result of taking a hash function from a malicious file associated with the given training alert message.

In some implementations of the method, the trained neural network is configured to identify less than 1% of false-positive alert messages on a random sample of alert messages that were not used for training the neural network.

In some implementations of the method, the neural network comprises three neural networks; and training the neural network comprises training a first neural network using those of the plurality of training alert messages, including network interaction data; training a second neural network using those of the plurality of training alert messages, including files data of; and training a third neural network using the host data associated with the plurality of training alert messages.

In some implementations of the method, the applying the neural network comprises: applying the first neural network to generate a first likelihood value of the at least one in-use alert message being false-positive; applying the second neural network to generate a second likelihood value of the at least one in-use alert message being false-positive; and applying the third neural network to generate a third likelihood value of the at least one in-use alert message being false-positive.

In some implementations of the method, the method further comprises determining a final likelihood value of the at least one in-use alert message being false-positive by determining a geometric mean of the first, second, and third likelihood values.

Further, in accordance with a second broad aspect of the present technology, there is provided server for determining a response to cyberthreats. The server comprises at least one processor and a non-transitory computer-readable memory storing executable instructions, which, when executed by the at least one processor, cause the system to: during a first phase, train a neural network to identify false-positive alert messages of information security systems, by: generating a cyberthreat database, the generating including acquiring, from a plurality of cyber-intelligence sources, data associated with a plurality of cyberthreats, the data, for a given cyberthreat of the plurality cyberthreats, including one or more selected from the group consisting of: a type of the given cyberthreat, one or more actor executing the given cyberthreat, means of executing the given cyberthreat, and indicators of compromise associated with the execution of the given cyberthreat; acquiring a plurality of training alert messages generated by information security systems, a given training alert message of the plurality of training alert messages being assigned with a respective label representative of whether the given training alert message is one of (i) an alert message that has been generated in response to an actual cyberthreat; and (ii) a false-positive alert message that has been generated without an influence of the actual cyberthreat; the given training alert message being associated with: (i) internal alert data extracted from the given training alert message; and (ii) host data of the given alert message, including data of a respective host having triggered generation of the given training alert message; using the internal alert data and the host data associated with the given training alert message to query an Internet graph model to identify additional data for the given training alert message; using the internal alert data, the host data, and the additional data associated with the given training alert message to query the cyberthreat database to identify enrichment data associated with the given training alert message; generating a respective vector for the given training alert message using: (i) the internal alert data; (ii) the host data; (iii) the additional data; (iv) the enrichment data associated with the given training alert message; and (iv) the respective label thereof; feeding the respective vector associated with the given alert message to the neural network, thereby causing the neural network to generate an intermediate prediction of whether a given in-use alert message is false-positive; optimizing a difference between the intermediate prediction and the respective label associated with the given training alert message, thereby training the neural network to determine whether the given in-use alert message is false-positive. Further, during a second phase, following the first phase, in response to receiving, by a computing device, communicatively coupled to the at least one processor, at least one in-use alert message from a respective information security system, the executable instructions cause the server to execute: retrieving, on the computing device, in-use host data and in-use internal alert data associated with the at least one in-use alert message; using the in-use internal alert data and the in-use host data to query the Internet graph model to identify in-use additional data for the at least one in-use alert message; using the in-use internal alert data, the in-use host data, and the in-use additional data associated with the at least one in-use alert message to query the cyberthreat database to identify in-use enrichment data associated with the at least one in-use alert message; generating a respective in-use vector for the at least one in-use alert message using: (i) the in-use internal alert data; (ii) the in-use host data; (iii) the in-use additional data; and (iv) the in-use enrichment data associated with the at least one in-use alert message; feeding the respective in-use vector to the trained neural network to generate a likelihood value of the at least one in-use alert message being a false-positive alert message; in response to the likelihood value being lower than a predetermined threshold value, causing the computing device to: identify the at least one in-use alert message as being generated in response to a respective actual cyberthreat; and respond to the respective actual cyberthreat; and in response to the likelihood value being equal to or greater than the predetermined threshold value, causing the computing device to identify the at least one in-use alert message as being a false-positive alert message in the respective information security system.

In some implementations of the system, at least one of the Internet graph model, the cyberthreat database, and the neural network are stored in memories of different servers communicatively coupled, over a communication network, to the at least one processor of the server.

In the context of the present specification, unless expressly provided otherwise, a computer system may refer, but is not limited, to an “electronic device”, an “operation system”, a “system”, a “computer-based system”, a “controller unit”, a “control device” and/or any combination thereof appropriate to the relevant task at hand.

In the context of the present specification, unless expressly provided otherwise, the expression “computer-readable medium” and “memory” are intended to include media of any nature and kind whatsoever, non-limiting examples of which include RAM, ROM, disks (CD-ROMs, DVDs, floppy disks, hard disk drives, etc.), USB keys, flash memory cards, solid state-drives, and tape drives.

In the context of the present specification, a “database” is any structured collection of data, irrespective of its particular structure, the database management software, or the computer hardware on which the data is stored, implemented, or otherwise rendered available for use. A database may reside on the same hardware as the process that stores or makes use of the information stored in the database or it may reside on separate hardware, such as a dedicated server or plurality of servers.

In the context of the present specification, unless expressly provided otherwise, the words “first”, “second”, “third”, etc. have been used as adjectives only for the purpose of allowing for distinction between the nouns that they modify from one another, and not for the purpose of describing any particular relationship between those nouns.

### BRIEF DESCRIPTION OF THE DRAWINGS

For a better understanding of the non-limiting embodiments of the present technology, as well as other aspects and further features thereof, reference is made to the following description which is to be used in conjunction with the accompanying drawings, where:

FIG. 1A depicts a schematic diagram of a system that can be used for implementing at least some non-limiting embodiments of the present technology;

FIG. 1B depicts examples of alerts, in accordance with certain non-limiting embodiments of the present technology;

FIG. 2 depicts a flowchart of a training phase of a present method for determining responses to cyberthreats, in accordance with certain non-limiting embodiments of the present technology;

FIG. 3 depicts a flowchart of a strep for processing alerts for use in the present method, in accordance with certain non-limiting embodiments of the present technology;

FIG. 4 depicts a flowchart of an in-use phase of the present method for determining responses to cyberthreats, in accordance with certain non-limiting embodiments of the present technology; and

FIG. 5 depicts a schematic diagram of a computing environment that can be used for implementing the system of FIG. 1A, in accordance with certain non-limiting embodiments of the present technology.

### DETAILED DESCRIPTION

The following detailed description is provided to enable any one skilled in the art to implement and use the non-limiting embodiments of the present technology. Specific details are provided merely for descriptive purposes and to give insights into the present technology, and no was as a limitation. However, it would be apparent for the person skilled in the art that some of these specific details may not be necessary to implement certain non-limiting embodiments of the present technology. The descriptions of specific implementations are only provided as representative examples. Various modifications of these embodiments may become apparent to the person skilled in the art; the general principles defined in this document may be applied to other non-limiting embodiments and implementations without departing from the scope of the present technology.

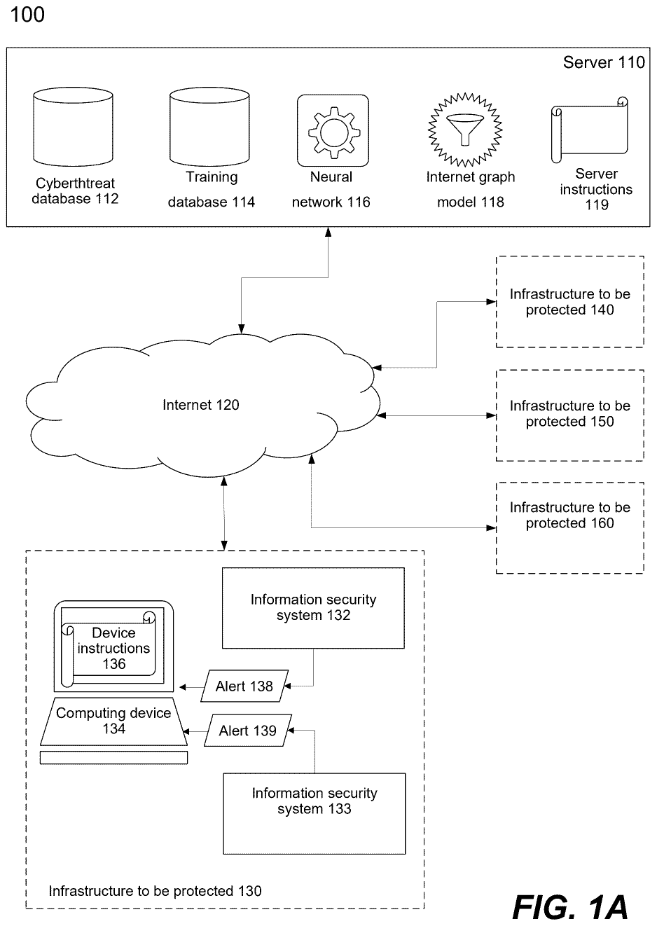

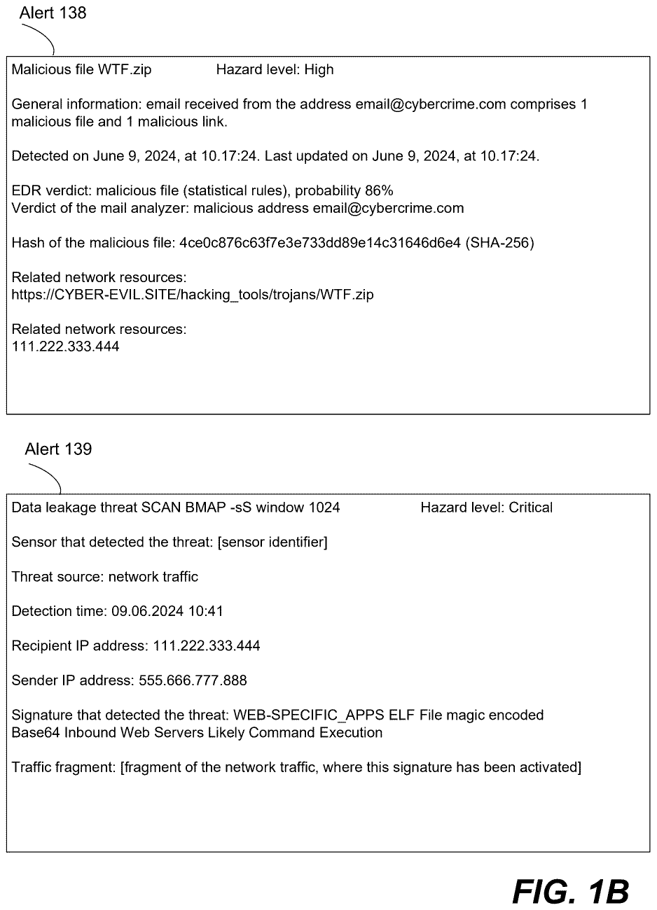

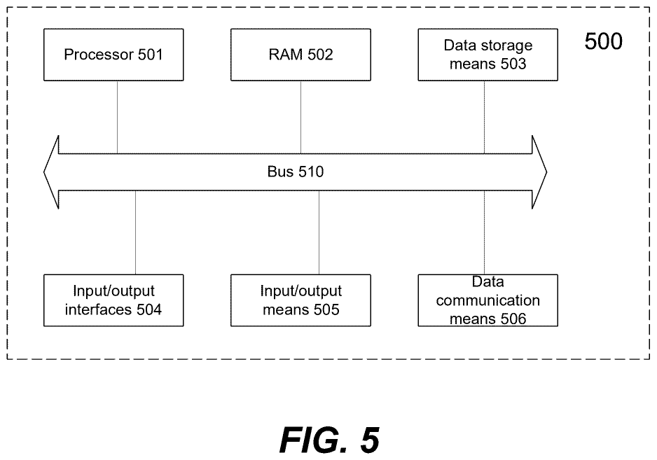

With initial reference to FIG. 1A, there is depicted an example system 100 that can be used for implementing the present method for determining a response to cyberthreats, in accordance with certain non-limiting embodiments of the present technology. According to certain non-limiting embodiments of the present technology, the system 100 can comprise a server 110, which comprises at least one processor (such as a processor 501 of a computing environment 500 schematically depicted in FIG. 5) that is configured to execute server machine-readable instructions 119, thereby causing the server 110 to execute the present method. As will become apparent from the description provided hereinbelow, the server 110 can be configured to cause a computing device 134, communicatively coupled to the server 110, to execute device machine-readable instructions (136). According to certain non-limiting embodiments of the present technology, the computing device 134 can be coupled to the server 110 via a communication network 120, which can be for example, the Internet. However, in other non-limiting embodiments of the present technology, the communication network 120 can comprise a wide area network (WAN) or a local area network (LAN).

In some non-limiting embodiments of the present technology, the server 110 can be implemented as a conventional computer server and may comprise some or all of the components of the computing environment of FIG. 5. In one non-limiting example, the server 110 is implemented as a Dell™ PowerEdge™ Server running the Microsoft™ Windows Server™ operating system but can also be implemented in any other suitable hardware, software, and/or firmware, or a combination thereof. In the depicted non-limiting embodiments of the present technology, the server 110 is a single server. In alternative non-limiting embodiments of the present technology (not depicted), the functionality of the server 110 may be distributed and may be implemented via multiple servers. These servers may be located both in a single data center and in several data centers, including those located in various countries.

According to certain non-limiting embodiments of the present technology, the implementation of the computing device 134 is not limited and may include, for example, a server, a personal computer, both a desktop computer and a portable computer, i.e., a notebook such as, e.g., an ASUS Zenbook notebook. In an alternative embodiment, the computing device (134) also may be a mobile device, e.g., a smartphone or a tablet. To this end, the computing device 134 can also include some or all components of the computing environment 500 of FIG. 5.

Further, according to certain non-limiting embodiments of the present technology, the computing device (134) can be configured to receive alerts, such as a first alert (138) and a second alert 139, from at least one information security system, such as a first information security system (132), that is preliminarily installed in a given infrastructure (130) to be protected. Other information security systems, such as a second information security system (133) installed therein, configured to generate the second alert (139) and transmit it to the computing device (134). The total number of the information security systems within the given infrastructure 130 to be protected is not limited, and can comprise 5, 10, or even 20, without departing from the scope of the present technology.

According to certain non-limiting embodiments of the present technology, a given one of the first and second information security systems (138), (139) may be one of from the following non-exhaustive examples: an Intrusion Detection System (IDS) system; a Next-Generation Firewall (NGFW) system; an Endpoint Detection and Response (EDR) system; a Web Application Firewall (WAF) system; a Security Information and Event Management (SIEM) system; an Extended Detection and Response (XDR) system; an External Attack Surface Management (EASM) system; an Identity and Access Management (IAM) system; a Unified Threat Management (UTM) system; a Cloud Access Security Broker (CASB) system; a Cloud-Native Application Protection (CNAP) system; a Cloud Security Posture Management (CSPM) system; a Cloud Infrastructure Entitlement Management (CIEM) system; a Cloud Workload Protection Platform (CWPP) system; a monitoring system; and a visualization system. Each of the systems (132), (133) may be a random information security system under proviso that it is configured to send the alerts either via a local area network or via Internet.

The device machine-readable instructions (136) that are stored in an internal memory of the computing device (134) may be preliminarily created by means of any programming or scripting language such as C, C++, C #, Java, JavaScript, VBScript, Macromedia Cold Fusion, COBOL, Microsoft Active Server Pages, assembler language, Perl, PHP, AWK, Python, Visual Basic, etc. For example, in some non-limiting embodiments of the present technology, the device machine-readable instructions (136) may be represented by a script developed in the JavaScript language that is launched in a browser application, such as a Microsoft Edge™ browser application or a Google Chrome™ browser application.

Also, aside from the computing device (134), the given infrastructure (130) to be protected can include a other hosts (servers, working stations, notebooks, etc., not depicted in FIG. 1A) that are united by at least one computer network, and their functioning represents a purpose of this infrastructure.

It should be noted that in the context of the present specification, the term “host” denotes a computer network node. The hosts may be both physical devices, i.e., computers, servers, notebooks, smartphones, tablets, game consoles, TV sets, printers, network hubs, switches, routers, random devices united by the IoT (“Internet of things”) technology, etc., and firmware solutions that allow to organize several network nodes on a single physical device, e.g., so-called virtual hosts Apache, etc.

Further, in the context of the present specification, the term an “internal host” means a host that is located within the infrastructure to be protected, such as the given infrastructure 130. On the other hand, an “external host” or an “external web resource” denote a host that is located outside the given infrastructure (130) to be protected, but that is accessible via communication network (120).

The server (110) that is also configured to exchange traffic via communication network 120 is not a part of the given infrastructure (130) to be protected, that is, physically and logically disposed outside thereof.

According to certain non-limiting embodiments of the present technology, an internal memory of the server (110), such as a storage 503 of the computing environment 500, can be configured to store at least one of: an cyberthreat database (112), a training database (114), a machine-learning (ML) model (116), an Internet graph model (118) as well as the server machine-readable instructions (119) which, upon execution by the at least one processor of the server (110), cause the implementation of the present method.

It should be expressly understood more infrastructures (i.e., computer networks) can be communicatively coupled to the server 110 via the communication network 120 for protection. For example, as it can be appreciated from FIG. 1A, aside from the given infrastructure 130, there could be coupled to the server 110, at least, a first infrastructure 140, a second infrastructure 150, and a third infrastructure 160, each of which may include a respective computing device, similar to the computing device 134, and a respective information security system running therein, which can be implemented similar to one of the first information security system (132).

With reference to FIG. 1B, there are depicted examples of alerts, generated the information security systems, such as the first and second alerts 138, 139, that can used for analyzing, in accordance with certain non-limiting embodiments of the present technology. Each of the first and second alerts 138, 139 is a message that is displayed on a user interface of the respective information security system and/or transmitted by the respective information security system via a suitable communication link.

As best seen from FIG. 1B, each of the first and second alerts 138, 139 comprises a general information about an event that is addressed by the alert, as well as some specific details: which information security system has detected the threat and when, what is this threat, what are the known external network resources associated with this threat, etc.

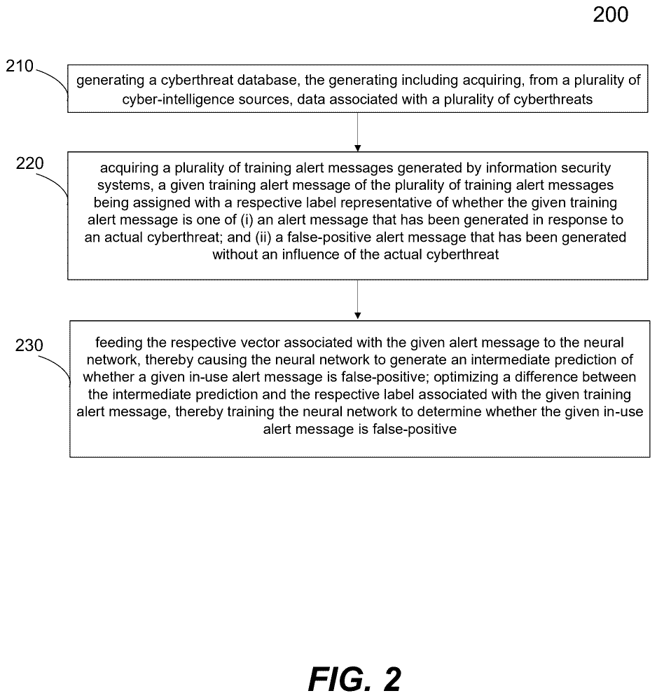

With reference to FIG. 2A, there is depicted a training phase (200) of the present method for determining responses to cyberthreats, in accordance with certain non-limiting embodiments of the present technology. The training phase 200 can be executed by the processor 501 of the server 110.

Step 210: Generating a Cyberthreat Database, the Generating Including Acquiring, from a Plurality of Cyber-Intelligence Sources, Data Associated with a Plurality of Cyberthreats

The training phase 200 commences at step (210) with the processor 501 being configured to collect, from cyber-intelligence sources, and store in the cyberthreat database 112, hosted by the server (110), data about cyberthreats of the computing devices and actors that implemented these threats, about means, methodologies, and tactics utilized by these actors, as well as about compromise indicators that arise due to implementation of said threats.

According to certain non-limiting embodiments of the present technology, the cyber-intelligence sources can include without limitation:
Open-source intelligence that is also known as OSINT. In this case, the open sources mean social media such as X (“Twitter”), blogs, forums and other web resources that are characterized by everyday appearance of a large amount of content that is generally published by a random number of authors.
Intelligence in closed forums that are frequently used by cybercriminals being so-called Deep Web and Dark Web. Technically, these resources are similar to open blogs and forums, however, due to specificity of topics discussed therein, they are not accessible for a random Internet user. Cybersecurity professionals access these closed resources usually by social engineering methods: by pretending to be cybercriminals who are interested in discussing specific topics such as purchase of malicious software, purchase of stolen accounts, etc.
Structured data flows about malicious software that are also known as Malware feeds. Usually, they are generated by companies and communities that work in the field of cybersecurity and are publicly accessible.
The structured data flows about indicators of compromise, i.e., those digital footprints that are left in the computing devices, such as the computer device 134, after it has been compromised. Similarly to the previously mentioned sources, these data flows that are also known as IoC feeds are generated by companies and communities that work in the cybersecurity field and are publicly accessible.
Reports of analytical online services such as VirusTotal have the same purpose as the previously mentioned sources and are publicly accessible.
List of known vulnerabilities and security defects that are also known as Common Vulnerability and Exposure (CVE). Usually, after a certain software or hardware vulnerability is detected, it will be registered in the list under a unique number and provided with a description in the following form: this problem in this version of this product results in said malicious effect as a result of attack of a mentioned type. The CVE list is publicly accessible.
Lists of intruders and cybercrime groups that are compiled and maintained by communities of cybersecurity professionals; and they are publicly accessible as well.
Lists of tactics, methodologies, and procedures used by the cybercrime groups and intruders that are compiled and maintained by communities of cybersecurity professionals similarly to the previous ones; and they are publicly accessible.
Databases of domains, IP addresses, and links used for phishing and other fraudulent activities. Similarly to the previous ones, they are compiled and maintained by communities of cybersecurity professionals; and they are publicly accessible.
Program source code repositories.
Websites that provide services for publishing source code texts of the programs such as Pastebin, are publicly accessible, and comprise source codes of a large number of programs. In addition to other programs, examples of exploits, i.e., malicious programs that are intended to utilize known vulnerabilities, fragments of codes with passwords, API keys, and other sensitive information, appear therein. Sometimes, the intruders publish information about purposes of future attacks and instructions for conduction thereof at such websites, thereby allowing to supplement the lists of their tactics, methodologies, and procedures.
Websites that provide services for exchange of hyperlinks are often used by the cybercriminals for publishing malicious links. These resources are publicly accessible.
Repositories of exploits, i.e., malicious programs that are intended to use known vulnerabilities and security defects (CVE), as well as
Repositories of templates of fraudulent websites that are also known as phishing kits are compiled and maintained by the community of cybersecurity professionals; and they are publicly accessible.
Configuration files retrieved from a composition of the malicious software, as well as
Results of reverse engineering of the malicious software that are usually reports generated by companies that specialize in the cybersecurity field. Usually, they are published in corporate sites, blogs, and publicly accessible.
Honeypots.
Virtual machines or “sandboxes” that are computing systems configured to automatically retrieve artifacts of the malicious software that characterize this malicious software such as IP addresses of command servers, compromise indicators, etc. Usually, organization and launch of these computing systems are performed by companies that work in the cybersecurity field for their own purposes.
Scanners of IP addresses and crawlers, which are automated computing systems that allow to obtain data about a wide range of Internet-accessible web resources and their parameters, in particular, domain names, IP addresses, open ports, services launched thereon, etc. Usually, organization and launch of these computing systems are performed by the companies that work in the cybersecurity field for its own purposes.
Telemetry of various information security systems is represented by data about computing devices that are protected by these systems, both about their normal operation and about known incidents. Automated collection of this data is a common practice among companies that produce certain information security systems. For example, with back reference to FIG. 1A, it may be said that the information security systems having a telemetry that is used on the server (110) during protection of the given infrastructure (130) may be information security systems that operate within the first, second, and third infrastructures (140), (150) and (160) to be protected.

It must be expressly understood that the above list of cyber-intelligence sources, from which the processor 501 can be configured to acquire the data on cyberthreats, is non-exhaustive and other open and closed sources including information on cyberthreats are envisioned without departing from the scope of the present technology.

According to certain non-limiting embodiments of the present technology, the data about the cyberthreats collected from the open and closed sources mentioned above can include, for a given cyberthreat, at least one of: domain names associated with the given cyberthreat, IP addresses associated with the given cyberthreat, results of taking a hash function from malicious files or web pages associated with the given cyberthreat, and hyperlinks (URL) to malicious web resources associated with the given cyberthreat.

According to certain non-limiting embodiments of the present technology, the processor 501 can be configured to collect the data about cyberthreats using preliminarily created scripts that are configured for breaking down (“parsing”) message texts on the social media and forum web pages, lists, and structured data flows. How the cyberthreat database (112) is organized, including its rubrication, and a process for storing the data therein is not limited.

The training phase 200 hence advances to step 220.

STEP 220: Acquiring a Plurality of Training Alert Messages Generated by Information Security Systems, a Given Training Alert Message of the Plurality of Training Alert Messages Being Assigned with a Respective Label Representative of Whether the Given Training Alert Message is One of (I) an Alert Message that Has Been Generated in Response to an Actual Cyberthreat; and (II) a False-Positive Alert Message that has Been Generated Without an Influence of the Actual Cyberthreat

At step (220), according to certain non-limiting embodiments of the present technology, the processor 501 can be configured for receiving and storing, in the training database (114) hosted by the server 110, internal alert data of training alerts of the information security systems such as the alerts (138), (139) of the first and second information security systems 132, 133, respectively, as well as data about a local context of each of the alerts, as will be described in detail below.

According to certain non-limiting embodiments of the present technology, the data about the local context of each of the training alerts includes data of a respective host that has triggered the generation of a given training alert on the respective information security system. According to certain non-limiting embodiments of the present technology, the host data can include at least one of the following:
a name of the respective host within an infrastructure to be protected where the given training alert message has been generated, e.g., Acc_Jones;
user accounts that are present at the respective host, e.g., JJones, SBuddy, Admin18, Guest;
privilege levels of each of the user accounts: guest, user, administrator, etc.;
an organizational and staff structure associated with the name of the respective host: an accounting department, a design department, a development department, etc.;
an organizational and staff structure of each users associated with the respective host, e.g., a first user relates to the accounting department, a second user relates to a security service, an administrator relates to a system administration service, the Guest account does not relate to any of the departments;
a local network domain associated with each user that is associated with the respective host, e.g., the first user and the second user relate to Office domain, while the administrator relates to SYST domain;
a technical configuration of the respective host, including one selected from the group consisting of: a server, a desktop computer, a notebook, a tablet, a smartphone, a video camera, a multifunctional device, and a printer; and
other alert messages having been generated in the respective host.

According to certain non-limiting embodiments of the present technology, the processor 501 can be configured to assign the given training alert with a respective label, which is indicative of whether the given training alert is an alert generated in response to an actual threat or false-positive.

Further, according to certain non-limiting embodiments of the present technology, the processor 501 can be configured to label the training alerts stored in the training database 114 as alerts comprising network interaction data and alerts comprising files data. The alerts comprising the network interaction data characterized in that they comprise any identifier, e.g., IP address of the external host. For example, the second alert (139 in FIG. 1B is a network interaction data alert as it informs that a query to the external web resource 111.222.333.444 has been made from the host of the given infrastructure 130 to be protected having the IP address 555.666.777.888.

The training alerts including the files data are characterized in that they comprise any identifier, e.g., a name of the file for which the operations have been executed on one of the hosts of the infrastructure to be protected. For example, the first alert (138) in FIG. 1B a files data alert as it informs about receipt of the email with a file WTF. zip enclosed. In another example, the alert (not illustrated in FIG. 1B) may inform that the executable file WTF. EXE is launched on the internal host 555.666.777.888.

It shall be understood that the first alert (138) also may serve as an example of the alert comprising the network interaction data. Therefore, the same alert such as the first alert (138) may be classified as both, a network interaction data and files data alert.

In some non-limiting embodiments of the present technology, the training alerts can be labelled by soliciting respective labels from human operators. However, automatic labelling techniques are also envisioned.

How the training database (114) is organized, including its rubrication, and a process for storing the data therein is not limited.

Further, according to certain non-limiting embodiments of the present technology, the processor 501 can be configured to receive and store, on the computing device (134), settings, including at least data about at least one section of the at least one information security system that produces the given training alert to be processed, as well as data about actions for responding to a cyberthreat associated with the given training alert.

It shall be understood that if there are more than one information security systems, e.g., the first and second information security systems 132, 133, as illustrated in FIG. 1A, the stored settings must comprise data about each of the present systems as well as data about those sections (functional units) of the systems that produce the alerts to be processed. For example, an interface of the information security system may be a window with several tabs: “Alerts”, “Incident management”, “Signatures”, “Settings”. In order to ensure correct operation of the system that implements the disclosed process, the “Alerts” tab must be indicated in the settings.

Further, according to certain non-limiting embodiments of the present technology, a list of possible actions for responding to the respective cyberthreat associated with a given alert on the computing device 134, either during the training or in-use phases 200, 400, can include:
causing the computing device 134 to end a process associated with the respective cyberthreat;
isolating the computing device 134;
generating a memory dump of the computing device 134;
sending a warning notification comprising the at least one selected from the group consisting of in-use alert, the threat data, and the additional data to an operator of the respective information security system;
escalating responding to the respective actual cyberthreat;
restoring an operating system of the computing device 134 to its initial state before the respective cyberthreat; and
adding, to a block list, a result of taking a hash function from a malicious file, a domain name, a URI, a URL, and an IP address, associated with the respective cyberthreat.

It should be also that use of such notifying tool as API events allows easy implementation of an additional integration of the disclosed system with various third-party tools such as brandmauers, firewalls, etc. The generation of all the above-listed notifications such as emails, SMS, MMS, push notifications, etc., for transmitting by the computing device 134 may be performed in any suitable way.

Further, according to certain non-limiting embodiments of the present technology, the processor 501 can be configured to extract internal alert data from each one of the training alerts obtained earlier. According to certain non-limiting embodiments of the present technology, the internal alert data served as a basis for generating the respective training alert by the information security system upon detection of this alert. As illustrated previously in FIG. 1B, the internal alert data may include:
a name of a potential cyberthreat associated with the given training alert message, e.g., SCAN BMAP-sS window 1024;
a hazard level of the potential cyberthreat, e.g., High or Critical;
an IP address of a server associated with the potential cyberthreat, e.g., 111.222.333.444;
a domain name associated with the potential cyberthreat, e.g., CYBER-EVIL.SITE;
a hyperlink or a URL associated with the potential cyberthreat, e.g., https://CYBER-EVIL.SITE/hacking_tools/trojans/WTF. zip;
a result of taking a hash function from a potentially malicious file associated with the potential cyberthreat, e.g., 4ce0c876c63f7e3e733dd89e14c31646d6e4;
a name of a signature that detected the potential cyberthreat, e.g., File magic encoded Base64 Inbound Web Servers Likely Command Execution;
a content of the signature that detected the potential threat;
a textual description of the signature that detected the potential threat; and
a data fragment which the signature that detected the potential threat triggered to. For example, if the signature is intended to detect a malicious traffic, the data fragment may be a network traffic fragment.

It should be noted that the internal alert data may be different in each specific training or in-use alert. For example, one alert may comprise only the threat name, the threat hazard level, and the IP address. At the same time, another alert may comprise the threat name, the threat hazard level, the name of the signature that detected the potential threat; the content of the signature that detected the potential threat, the data fragment which the signature that detected the potential threat triggered to, and the textual description of the signature that detected the potential threat.

As a non-limiting example, let's consider a situation, where the threat name, e.g., SCAN BMAP-sS window 1024, the threat hazard level, e.g., Critical, and the IP address, e.g., 111.222.333.444, were retrieved from another alert.

The retrieval of the above-described internal alert data may be performed in any suitable way—for example, by the processor 501 using a preliminarily prepared script that is configured to break down (“parse”) the text of the given training alert's message. Also, in other non-limiting embodiments of the present technology, the processor 501 can be configured to employ other techniques for extracting the internal alert data from the given training alert, such as, computer vision, optical character recognition (OCR), preliminarily trained neural network or other suitable approaches without departing from the scope of the present technology.

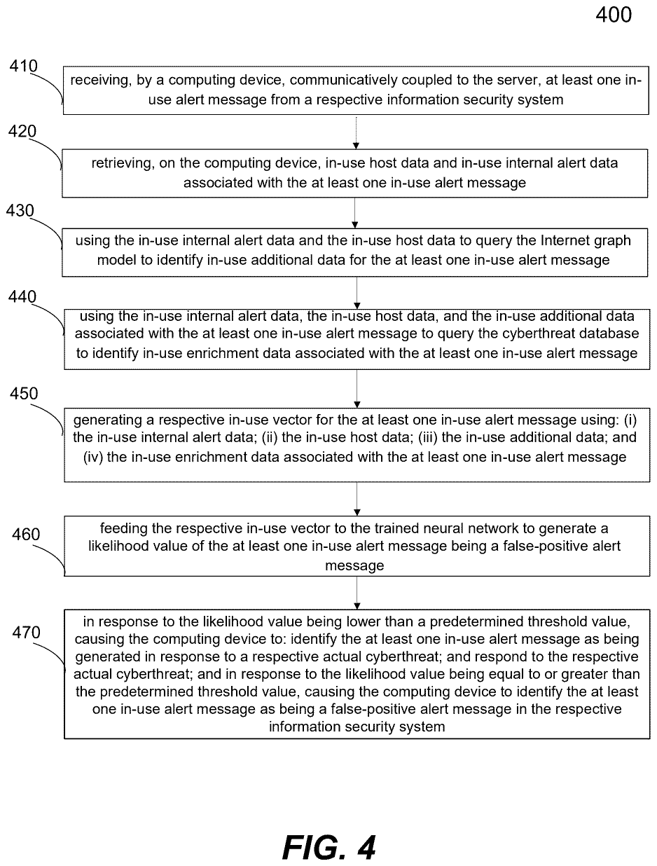

During the training stage (200) of the present method, the retrieval of the host and internal alert data of the given training alert is executed on the server (110), and to this end, a software implementation of this algorithm (the above-mentioned script) is preliminarily included into the server machine-readable instructions (119). During the in-use stage (400) of the present method, described below with reference to FIG. 4, the processor 501 of the server 110 causes the computing device 134 to execute the same actions, and to this end, a software implementation of this algorithm is preliminarily included into the device machine-readable instructions (136).

After obtaining the host data and the internal alert data of the plurality of training alerts, according to certain non-limiting embodiments of the present technology, the processor 501 of the server 110 can be configured to generate a training set of data to train the ML model 116 to determine whether a given in-use alert is false-positive or not. To this end, step 220 is broken down into several sub-steps, which will be explained immediately below.

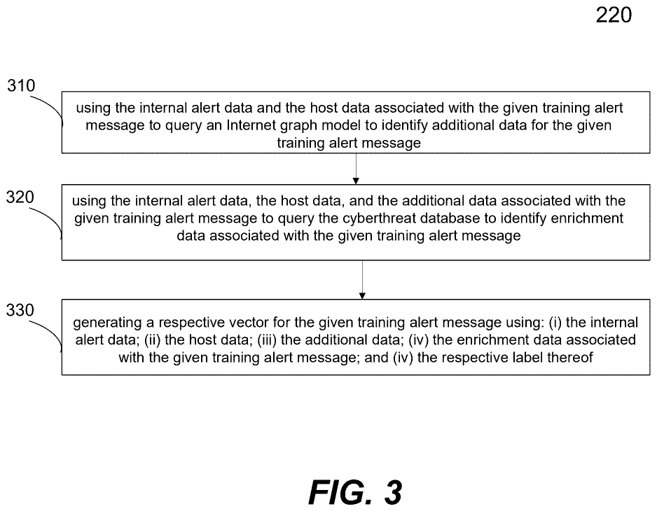

With reference to FIG. 3, there is depicted a flowchart diagram of step 220 of the training phase 200, in accordance with certain non-limiting embodiments of the present technology.

### Sub-Step 310: Using the Internal Alert Data and the Host Data Associated With the Given Training Alert Message to Query an Internet Graph Model to Identify Additional Data for the Given Training Alert Message

At step 310, according to certain non-limiting embodiments of the present technology, the processor 501, can be configured to use the host data and the internal alert data of the given training alert to query the Internet graph model (118) of the communication network 120 to identify additional data associated with the given training alert.

It is not limited how the Internet graph model (118) can be generated. For example, in some non-limiting embodiments of the present technology, the Internet graph model 118 may be generated in accordance with a method described in a co-owned U.S. Pat. No.: 11,005,779-B2, issued on May 11, 2021 and entitled “METHOD OF AND SERVER FOR DETECTING ASSOCIATED WEB RESOURCES,” the content of which is incorporated by reference in its entirety. More specifically, according to at least some non-limiting embodiments of the present technology of this method, to generate the Internet graph model 118, the processor 501 of the server 110 can be configured to: (i) scan the communication network 112; (ii) identify a first network resource and a second network resource from a plurality of network resources; (iii) acquire data associated with the first network resource and the second network resource, the data including at least one parameter of the first network resource and at least one parameter of the second network resource; then, (iv) in response to a correspondence between the at least one parameter of the first network resource and the at least one parameter of the second network resource, determining a relation (a graph edge) between the first network resource (a first graph node) and the second network resource (a second graph node), thereby forming the Internet graph model 118.

Further, how the processor 501 of the server 110 can be configured to search the Internet graph model (118) is also not limited. For example, in some non-limiting embodiments of the present technology, the processor 501 can be configured to traverse the Internet graph model 118 in accordance with one of the methods described in a co-owned United States Patent Application Publication No.: 2022/0407,875-A1, published on Dec. 22, 2022 and entitled “SYSTEM AND METHOD FOR DETECTION OF MALICIOUS NETWORK RESOURCES,”the content of which is incorporated herein by reference in its entirety. More specifically, according to at least some non-limiting embodiments of the present technology of this method, the processor 501 can be configured to: (i) retrieve the internal alert data and the host data associated with the given training alert, e.g., the IP address 111.222.333.444; (ii) feed the host data and the internal alert data is fed to the Internet graph model 118, thereby identifying a graph of network resources that are associated with this IP address.

Further, according to certain non-limiting embodiments of the present technology, the processor 501 can be configured to augment the internal alert data, the host data, associated with the given training alert with the additional data, identified via the Internet graph model (118).

According to certain non-limiting embodiments of the present technology, the additional data may include, without limitation:
a name of an ownership company of an IP address of a server associated with a potential cyberthreat having triggered the given training alert message;
a hosting provider of the IP address;
a validity period of the IP address;
a list of ports that are open at this IP address;
a list of network services launched at this IP address;
a hash function of a sum of configurations of each of the list of network services;
types, names, and versions of programs installed on the computing device located at the IP address;
a tag that is a name of a cybercrime group or a malicious software;
a name of an ownership company of a domain associated with a potential cyberthreat;
a domain registrar of the domain;
a domain validity period of the domain;
a status of an SSL-or a TLS-certificate of the domain;
parameters of the SSL-or TLS-certificate, including encryption algorithms that may be used by a server, where the SSL-or TSL certificates are installed; and
a validity period of the SSL-or TLS-certificate.

In some non-limiting embodiments of the present technology, the processor 501 can be configured to filter the so identified additional data associated with the given training by dates associated with time intervals of the given training alert, thereby reducing a number of nodes and edges of the obtained graph. For example, by doing so, the processor 501 can be configured to exclude expired and historical data, e.g., that relate to events of five years ago, when this IP address might belong to other owners and used for other purposes, from consideration.

Step 220 hence advances to sub-step 320.

Sub-Step 320: Using the Internal Alert Data, the Host Data, and the Additional Data Associated with the Given Training Alert Message to Query the Cyberthreat Database to Identify Enrichment Data Associated with the Given Training Alert Message

At sub-step 320, according to certain non-limiting embodiments of the present technology, the processor 501 can be configured to enrich the internal alert data, the host data, and the additional data associated with the given training alert by data from the cyberthreat database (112), where the data from the cyber-intelligence sources has been stored as described above with regard to the step (210).

To that end, the processor 501 can be configured to generate, based on the internal alert data, the host data, and the additional data, a query for searching the cyberthreat database (112) to identify enrichment data for the given training alert. A syntax of the query itself as well as a general search method depend on a specific architecture and configuration of the cyberthreat database (112) and may be executed in any suitable way.

According to certain non-limiting embodiments of the present technology, the enrichment data associated with the given training alert can include, without limitation:
a name of malicious software associated with the given training alert message, e.g., Attila Stealer v.1.3;
a name of the cybercrime group associated with the potential cyberthreat having triggered the given training alert message, e.g., Zeus;
a nickname of the intruder associated with the potential cyberthreat having triggered the given training alert message, e.g., Datastream Cowboy;
a vulnerability designation, CVE, e.g., CVE-2023-0294;
a set of tactics, methodologies, procedures that are typical for a specific group or intruder, e.g., T1030, T1567.002, T1537 (fragment);
at least one indicator of compromise;
a hyperlink to a malicious web resource, e.g., https://CYBER-EVIL. SITE/hacking_tools/trojans/WTF.zip;
an IP address associated with the given training alert message, e.g., 111.222.333.444;
a domain name, e.g., CYBER-EVIL.SITE;
a result of taking the hash function from the malicious file, e.g., 4ce0c876c63f7e3e733dd89e14c31646d6e4; and
a result of taking a hash function from a malicious file associated with the given training alert message.

Step 220 Hence Advances to Sub-step 330.

Sub-Step 330: Generating a Respective Vector for the Given Training Alert Message Using: (I) the Internal Alert Data; (II) the Host Data; (III) the Additional Data; (IV) the Enrichment Data Associated with the Given Training Alert Message; and (IV) the Respective Label Thereof

At sub-step 330 of step 220 of the training phase 200, according to certain non-limiting embodiments of the present technology, the processor 501 can be configured to vectorize: (i) the internal alert data; (ii) the host data; (iii) the additional data; (iv) the enrichment data associated with the given training alert message; and (v) the respective label thereof, thereby generating a respective vector for the given training alert message.

Broadly speaking, via the data vectorization, the processor 501 is configured to transform all data related to a given alert (whether training or in-use, described below) into a one-dimensional vector—a sequence of cells, each containing either a numerical or Boolean value (TRUE/FALSE). The length of this vector (number of cells) remains consistent for every alert.

According to certain non-limiting embodiments of the present technology, the processor 501 is configured to store the data in the vector based on a positional principle. For example, the respective vector can be organized as follows:
The first 120 cells (first sub-vector) are representative of the internal alert data;
The next 150 cells (second sub-vector) are representative of the host data; and
The subsequent 80 cells (third sub-vector) are representative of IP addresses associated with the given alert.

Further, within each sub-vector, information is similarly organized using the positional principle. For example:
In the first sub-vector, cells 1 to 4 encode the threat level, where TRUE in cell 1 indicates “Critical,” TRUE in cell 2 indicates “High,” TRUE in cell 3 indicates “Medium,” and so forth.

Each sub-vector is generated using different data and algorithms, as described below. Further, the processor 501 can be configured to concatenate these sub-vectors to generate the final vector representation for the given alert.

More specifically, according to certain non-limiting embodiments of the present technology, the processor 501 can be configured to generate a first sub-vector for the interna alert data associated with the given training alert as follows:
1) Name of the potential cyberthreat associated with the given training alert:
   A binary sub-vector is created, with a length equal to the number of known threat types. The threat type specified in the alert is marked TRUE in the corresponding cell (e.g., cell 1 for “Malicious File,” cell 2 for “Data Breach,” etc.).
2) Hazard level of the cyberthreat:
   A binary sub-vector is created, with a length equal to the number of predefined hazard levels (e.g., Critical, High, Medium). The hazard level specified in the alert is marked TRUE in the corresponding cell.
3) IP address associated with the potential cyberthreat:
   The IP address is not directly vectorized. Instead, it is used as a query to check against various sources, such as threat intelligence databases and publicly available lists of malicious IPs (e.g., projecthoneypot. org). A binary sub-vector is created, with each cell corresponding to a source. TRUE is recorded for any source indicating that the IP is malicious.
4) A name of a signature that detected the potential cyberthreat:
   The number of possible signatures is limited and predetermined. A binary sub-vector is created, with its length equal to the total number of known signatures. The specific signature that triggered the alert is marked as TRUE in the corresponding cell of the sub-vector. For example, the first cell may represent a signature related to “Malware Detection,” the second cell to “Data Breach Detection,” and so on.
5) Other elements, including: a domain name associated with the potential cyberthreat, a hyperlink associated with the potential cyberthreat, a result of taking a hash function from a potentially malicious file associated with the potential cyberthreat, a name of a signature that detected the potential cyberthreat:
   These are not directly vectorized but are used for querying the Internet graph model 118 and/or the cyberthreat database 112.

Further, the processor 501 can be configured to generate a second sub-vector for the host data associated with the given training alert as follows:
1) Host name of the respective host where the given training alert originated:
   A binary sub-vector is created, with a length equal to the number of hosts in the infrastructure. The specific host is marked TRUE in the corresponding cell.
2) User accounts present on the respective host:
   A binary sub-vector is created, with a length equal to the total number of user accounts in the organization. Accounts present on the respective host are marked TRUE.
3) Privilege levels of user accounts at the respective host:
   A numerical sub-vector is created, with each cell corresponding to a privilege level (e.g., Guest, User, Admin). Each cell stores the count of accounts with the respective privilege at the respective host.
4) Organizational and staff structure:
   Binary sub-vectors are created, a length of which represents a number of departments and services in a given organization. More specifically, such a sub-vector associated with the given organization includes a plurality of cells, each of which includes a binary value (TRUE/FALSE), representative of whether the corresponding department of the given organization utilizes the respective host that has triggered the given training alert.
   A numerical sub-vector is created, a length of which represents a number of departments and services in a given organization. More specifically, each cell of such the sub-vector includes a numerical value representative of a number of staff members in the corresponding department of the given organization having accounts at the respective host that has triggered the given training alert.
5) A technical configuration of the respective host, including one selected from the group consisting of: a server, a desktop computer, a notebook, a tablet, a smartphone, a video camera, multifunctional device, and a printer.
   A binary sub-vector is created, the length of which equals the number of device types. The type to which the host belongs is marked as TRUE in the sub-vector. For example, the first cell of the sub-vector represents “server,” the second cell represents “notebook,” and so on.
6) Association of the given host with domains of a local network:
   A numerical sub-vector is created consisting of a single cell. This cell stores a value representing the total number of alerts associated with the given host that have been generated within the last hour.
7) Other alert messages generated on the respective host:
   A binary sub-vector is created, a length of which equals a number of domains, the value of TRUE is assigned to the cell that is representative of a domain associated with the respective host.

Further, the processor 501 can be configured to generate a third sub-vector for the additional data associated with the given training alert as follows:
1) IP Address Information:
   IP addresses are vectorized similarly, as described above, using sources such as threat intelligence databases or public repositories to identify potential maliciousness.
2) Open Ports:
   A first sub-vector is created to indicate whether standard (or otherwise well-known or system) ports, such as ports with port numbers from 0 to 1023, the value of TRUE is assigned to those cells that correspond to open non-standard ports;
   A second single-cell sub-vector is created taking a value of TRUE if there is at least one non-standard open port.
3) Network services:
   A single-cell binary vector is created taking a value of TRUE if there is at least one suspicious network service.
4) Status and validity period of an SSL-or a TLS-certificate of the domain:
   If the status of the certificate is invalid and/or the validity period of the certificate is expired, a value TRUE is assigned to a respective cell, which is representative of the IP address being potentially malicious.
5) Installed software applications:
   A single-cell binary sub-vector is created, taking the value of TRUE if there is at least one vulnerable application installed at the respective host. To determine whether there is at least one vulnerable software application installed on the respective host, the processor 501 can be configured to verify all application installed at the respective host against a pre-compiled list of vulnerable software applications.
6) Other data identified through the search of the Internet graph model 118, including a name of an ownership company of an IP address, a validity period of the IP address, a hash function of a sum of configurations of each of the list of network services, software, a name of an ownership company of a domain, a domain registrar of the domain, a domain validity period of the domain:
   This data is not directly vectorized, but is used for determining, for example, whether a given IP address is relatively new, which may be indicative of the maliciousness of the given IP address. In this case, a respective TRUE value is entered in the sub-vector of the IP address.

Further, the processor 501 can be configured to generate a fourth sub-vector for the enrichment data associated with the given training alert as follows:
1) Name of malicious software:
   This data is not directly vectorized. However, if a search returns the name of any malicious software, the respective vector associated with the alert is updated with the value TRUE in the cell that corresponds to “associated malicious software.” This indicates a potential threat.
2) Name of a cybercrime group:
   Similar to malicious software, this data is not directly vectorized. If a search returns the name of a cybercrime group, the vector associated with the alert is updated with the value TRUE in the cell that corresponds to the associated cybercrime group.
3) Vulnerability designation value according to Common Vulnerability and Exposure (CVE):
   This data itself is not vectorized. However, if the search identifies any CVE indicators, the vector associated with the alert is updated with the value TRUE in the cell that corresponds to the associated vulnerability.
4) Compromise indicator:
   This data is not directly vectorized. However, if the search identifies any compromise indicators, the vector is updated with the value TRUE in the cell corresponding to the associated compromise indicator.
5) Newly identified IP address:
   The IP address itself is not vectorized but is used as a query in open sources (e.g., projecthoneypot. org). For each source that marks the IP as malicious, the corresponding cell in a binary sub-vector is updated with TRUE. For example:
      i. Cell 1 corresponds to a cybersecurity database.
      ii. Cell 2 corresponds to projecthoneypot. org, and so on.
6) Hash function result for a malicious file:
   This data is not directly vectorized. If the search identifies any malicious file hash, the vector is updated with the value TRUE in the corresponding cell.

In some non-limiting embodiments of the present technology, after vectorization, the processor 501 can be configured to apply one or more dimensionality reduction algorithms such as T-SNE, PCA, or UMAP.

Finally, according to certain non-limiting embodiments of the present technology, the processor 501 can be configured to encode the respective label by a Boolean value, that is, add a value of ‘1’ or ‘TRUE’ to the respective vector if the respective label is representative of the given training alert being false-positive, or else, add a value of ‘0’or ‘FALSE.’

Thus, the processor 501 of the server 110 can be configured to generate the respective vector for the given training alert, which is indicative of: (i) the internal alert data; (ii) the host data; (iii) the additional data; (iv) the enrichment data associated with the given training alert; and (v) the respective label thereof. By doing so, the processor 501 can be configured to generate the respective vectors for each training alert of the plurality of training alerts acquired earlier.

Sub-step 330 hence terminates and so does step 220 of the training phase 200 of the present method.

The training phase thus advances to step 230.

STEP 230: Feeding the Respective Vector Associated with the Given Alert Message to the Neural Network, Thereby Causing the Neural Network to Generate an Intermediate Prediction of Whether a Given In-Use Alert Message is False-Positive; Optimizing a Difference Between the Intermediate Prediction and the Respective Label Associated With the Given Training Alert Message, Thereby Training the Neural Network to Determine Whether the Given In-Use Alert Message is False-Positive

At step 230, according to certain non-limiting embodiments of the present technology, the processor 501 can be configured to feed the respective vectors for each training alert of the plurality of training alerts to the ML model 116, mentioned above with reference to FIG. 1A, for training the ML model 116 to determine whether the given in-use alert is false-positive or not. In some non-limiting embodiments of the present technology, the ML model 116 is a decision tree-based model, such as a random forest ML model or a gradient-boosted decision tree-based ML model. In other non-limiting embodiments of the present technology, the ML model 116 comprises a logistic regression. In yet other non-limiting embodiments of the present technology, the ML model 116 is a neural network, such as a Multi-Layer Perceptron (MLP) or a Feed-Forward neural network.

In some non-limiting embodiments of the present technology, the ML model 116 comprises three separate neural networks. In these embodiments, the processor 501 can be configured to train each of the three neural networks based on different training sets of data. More specifically, in some non-limiting embodiments of the present technology, the processor 501 can be configured to train a first neural network based on those respective vectors that are representative of training alerts comprising network interaction data. Further, processor 501 can be configured to train a second neural network based on those respective vectors that are representative of training alerts comprising files data. Finally, the processor 501 can be configured to train a third neural network based on those respective vectors that representative host data of the plurality of training alerts.

Therefore, in these embodiments, the processor 501 could be configured to preliminarily label the training alerts comprising the network interaction data at step (220) and store them in the training database (114) for further use in training the first neural network. As mentioned above, these training alerts are also assigned the respective label indicative of whether the given training alert is false-positive or not.

In some non-limiting embodiments of the present technology, a dataset of training alerts could consist of, for example, 10.000 alerts.

Also, in some non-limiting embodiments of the present technology, the processor 501 could be configured to preliminarily divide the dataset into three subsets: 80% for training, 10% for validation, and 10% for testing. In these embodiments, the ML is a Multi-Layer Perceptron, consisting of three sequential fully connected layers with batch normalization and ReLU activation, followed by an output layer with sigmoid activation. The processor 501 could be configured to use binary cross-entropy as the loss function during training and to use the stopping criterion as no improvement in validation loss for 10 consecutive epochs. In these embodiments the processor 501 could be configured to select the final model as a model with the lowest validation loss.

In other non-limiting embodiments of the present technology, the processor 501 could be configured to preliminarily divide the dataset into two subsets: 90% for training and 10% for testing. In these embodiments, the ML is a random forest classifier consisting of 100 trees with a maximum depth of 9 nodes. The processor 501 could be configured to use for training of each tree a randomly selected subset of 70% of the features. In these embodiments the processor 501 could be configured to apply the Gini criterion to determine the best splits within the decision trees. Also, the processor 501 could be configured to perform the training using cross-validation and to optimize classifier's parameters through hyperparameter search.

Similarly, the processor 501 could be configured to preliminarily label the training alerts comprising the files data at step (220) and store them in the training database (114) for further use in training the second neural network. As mentioned above, these training alerts are also assigned the respective label indicative of whether the given training alert is false-positive or not.

Similarly, the processor 501 could be configured to store the host data associated with each one of the plurality of training alerts in the training database 114 for further use in training the third neural network. As mentioned above, these training alerts are also assigned the respective label indicative of whether the given training alert is false-positive or not. Vectorization of each training set of data associated with each training alert for training the respective neural network is executed in the same manner as described above at sub-step 330 of step 220 of the training phase 200.

Thus, at a given training interaction, the processor 501 can be configured to feed to the ML model 116, the respective vector associated with the given training alert, thereby causing the ML model 116 to generate an intermediate prediction of whether the given training alert is false-positive. Further, the processor 501 can be configured to minimize a difference, which can be expressed by a respective value of a loss function (such as a cross-entropy loss function or a mean squared error loss function), thereby training the ML model 116 to determine whether the given in-use alert is false-positive or not.

In some non-limiting embodiments of the present technology, the ML model (116) is considered trained, when it is capable of identifying less than 1% of false-positive alerts on another plurality of alerts that was initially absent in the training database (114) and was not used for training the ML model 116. In other words, among every 100 alerts for which the ML model (116) has issued the “threat” verdict maximum one alert may not comprise any threat message, i.e., it may be a false-positive alert of the respective information security system.

Similarly, in those embodiments where the ML model 116 comprises three separate neural networks, the training of each neural network continues until the above criterion of identifying 1% of false-positive alerts is met by each of the neural networks.

It should be noted that steps (210), (220) and (230) that are illustrated in FIG. 2 as executed sequentially may be also executed simultaneously, i.e., in parallel to each other. Alternatively, the sequence of these steps may be random, including a case when it differs from the one illustrated in the drawing. It will not affect possibilities of the disclosed process.

The training phase 200 hence terminates, and the present method proceeds to the in-use phase 400, a flowchart diagram of which is depicted in FIG. 4, in accordance with certain non-limiting embodiments of the present technology. Akin to the training phase 200, the in-use phase 400 can be executed by the processor 501 of the server 110. However, the embodiments where the in-use phase 400 is executed by the computing device 134 are also envisioned.

### Step 410: Receiving, by a Computing Device, Communicatively Coupled to the Server, at Least One In-Use Alert Message From a Respective Information Security System

The in-use phase (400) starts a step (410) with the processor 501 of the server 110 being configured to determine whether the computing device 134 has received the given in-use alert, such as one of the first and second alerts (138), (139) from the at least one section of the respective one the first and second information security systems (132), (133) mentioned with reference to FIG. 1A. Further, the processor 501 can be configured to receive, from the computing device 134, the given in-use alert for analysis that is described below.

In some non-limiting embodiments of the present technology, the processor 501 can be configured for accumulating the incoming in-use alerts such as the first and second alerts (138), (139) during a predetermined period, e.g., during one minute or during five minutes.

The accumulated alerts can be stored in the non-volatile memory of the computing device (134) separately, e.g., in a separate folder having a name that represents a timestamp received from a system clock, e.g., 09.06.2024, 10:41. Further, the computing device 134 can be configured to transmit the accumulated in-use alerts to the server 110 for analysis.

The in-use phase hence advances to step 420.

### Step 420: Retrieving, on the Computing Device, In-Use Host Data and In-Use Internal Alert Data Associated With the at Least One In-Use Alert Message

At step 420, according to certain non-limiting embodiments of the present technology, the processor 501 can be configured to cause the computing device 134 to retrieve and transmit in-use internal alert data and in-use host data associated with the given in-use alert. The in-use internal alert data and the in-use host data are similar to the internal alert data and the host data of the given training alert described above at step 220 of the training phase 200.

This step is performed in a completely identical way as during step 220 of the training phase 200, and to this end, the software implementation of the algorithm for retrieving the in-use internal alert data and the in-use host data from the given in-use alert could be preliminarily included into the configuration of the device machine-readable instructions (136).

In some non-limiting embodiments of the present technology, the processor 501 can further be configured to determine, based on the in-use internal and in-use host data associated with the given in-use alert, whether the given in-use alert relates to the alerts comprising the network interaction data, to the alerts comprising the files data, to the alerts comprising both the network interaction data and the files data, or to the alerts comprising neither the network interaction data nor the files data.

This may be performed by the processor 501 searching, in the text of the given in-use alert, for pre-determined keywords such as “file”, “traffic”, etc.

The in-use phase 400 hence advances to step 430.

### Step 430: Using the In-Use Internal Alert Data and the In-Use Host Data to Query the Internet Graph Model to Identify In-Use Additional Data for the at Least One In-Use Alert Message

At step 430, according to certain non-limiting embodiments of the present technology, using the in-use internal alert data and the in-use host data associated with the given in-use alert, the processor 501 can be configured to query the Internet graph model (118) to identify in-use additional data associated with the given in-use alert. Querying the Internet graph model 118 can be performed in the same way as described above with regard to the sub-step (310) of step 220 during the training phase 200. In some non-limiting embodiments of the present technology, the computing device 134 can be configured to generate, based on the in-use internal alert data and the in-use host data, a query for querying the Internet graph model 118 and transmit this query to the server 110 for querying the Internet graph model 118. The so identified in-use additional data can be similar to the additional data associated with the given training alert.

The in-use phase 400 hence advances to step 440.

Step 440: Using the In-Use Internal Alert Data, the In-Use Host Data, and the In-Use Additional Data Associated with the at Least One In-Use Alert Message to Query the Cyberthreat Database to Identify In-Use Enrichment Data Associated with the at Least One In-Use Alert Message

Similar to sub-step 320 of step 220 of the training phase 200, at step 440, using the in-use internal alert data, the in-use host data, and the in-use additional data, the processor 501 can be configured to query the cyberthreat database (112) to identify in-use enrichment data associated with the given in-use alert.

The in-use phase 400 hence advances to step 450.

Step 450: Generating a Respective In-Use Vector for the at Least One In-Use Alert Message Using: (I) the In-Use Internal Alert Data; (II) the In-Use Host Data; (III) the In-Use Additional Data; and (IV) the In-Use Enrichment Data Associated With the at Least One In-Use Alert Message

At step 450, according to certain non-limiting embodiments of the present technology, the processor 501 can be configured to generate, based on the in-use internal alert data, the in-use host data, the in-use additional data, and the enrichment data to generate a respective in-use vector for the given in-use alert. According to certain non-limiting embodiments of the present technology, step 450 can be executed by the processor 501 in the same way as during sub-step 330 of step 220 of the training phase 200.

The in-use phase 400 hence advances to step 460.

### STEP 460: Feeding the Respective In-Use Vector to the Trained Neural Network to Generate a Likelihood Value of the at Least One In-Use Alert Message Being a False-Positive Alert Message

At step 460, according to certain non-limiting embodiments of the present technology, the processor 501 can be configured to feed the respective in-use vector to the ML model 116 trained as described above with respect to the training phase 200. In response, the ML model 116 is configured to generate a likelihood value of the given in-use alert being false-positive.

In those embodiments where the ML model 116 comprises three neural networks, the processor 501 can be configured to feed respective in-use vector to each of the neural networks, thereby causing them to generate a respective likelihood value of the given in-use alert being false-positive. In some non-limiting embodiments of the present technology, the processor 501 can further be configured to select the likelihood value which has been generated by a neural network having the highest predetermined priority.

In some non-limiting embodiments of the present technology, if the given in-use alert has been identified as an alert comprising the network interaction data, a higher priority (e.g., a preset weight factor such as 1.5 or 10) at step (460) will be assigned to predictions of the first neural network that is preliminarily trained on the training alerts comprising the network interaction data.

Similarly, if the given in-use alert has been identified as an alert comprising the files data, the higher priority at step (460) will be assigned to predictions of the second neural network that is preliminarily trained on the training alerts comprising the files data.

If the given in-use alert has been identified as an alert comprising both the network interaction data and the files data, then the higher priority (e.g., a predetermined weight factor) at step (460) will be assigned to the predictions of the first and second neural networks that have been preliminarily trained on the training alerts comprising the network interaction data and the files data, respectively.

If the given in-use alert has been identified as an alert comprising neither the network interaction data nor the files data, then a higher priority (e.g., a preset weight factor) at step (460) will be assigned to the predictions of the third neural network that has been preliminarily trained on the host data associated with the training alerts.

After the processor 501 has received, from each of the neural networks, the respective likelihood values with respect to the given in-use alert, the processor 501 can further be configured to generate a final likelihood value based on all the respective likelihood values with consideration of the higher priorities. For example, in some non-limiting embodiments of the present technology, the processor 501 can be configured to determine the final likelihood value as a geometrical mean of all the respective likelihood values. However, other approaches to determining the final likelihood value are envisioned, including determining an arithmetic mean, a harmonic mean, etc.

The in-use phase 400 hence advances to step 470.

STEP 470: In Response to the Likelihood Value Being Lower than a Predetermined Threshold Value, Causing the Computing Device to: Identify the at Least One In-Use Alert Message as Being Generated in Response to a Respective Actual Cyberthreat; and Respond to the Respective Actual Cyberthreat; and in Response to the Likelihood Value Being Equal to or Greater than the Predetermined Threshold Value, Causing The Computing Device to Identify the at Least One In-Use Alert Message as Being a False-Positive Alert Message in the Respective Information Security System

At step 470, in response to determining that the respective likelihood value for the given in-use alert determined at step 460 is lower than a predetermined likelihood threshold, the processor 501 can be configured to determine the given in-use alerts as being generated in response to an actual cyberthreat. To this end, the processor 501 can be configured to cause the computing device 134 to respond to the actual cyberthreat with one or more corresponding actions from those mentioned above with respect to step 220 of the training phase 200.

However, if the respective likelihood value is equal to or greater than the predetermined likelihood threshold, the processor 501 can be configured to determine the given in-use alert as being false-positive in the respective information security systems. Further, according to certain non-limiting embodiments of the present technology, the processor 501 can be configured to identify the given in-use alert as a false-positive one of the respective information security system.

The in-use phase 400 hence terminates, and so does the present method.

### Computing Environment

With reference to FIG. 5, there is depicted an example functional diagram of the computing environment 500 configurable to implement certain non-limiting embodiments of the present technology including the training and in-use phases 200, 400 of the present method, described above.

In some non-limiting embodiments of the present technology, the computing environment 500 may include: the processor 501 comprising one or more central processing units (CPUs), at least one non-transitory computer-readable memory 502 (RAM), a storage 503, input/output interfaces 504, input/output means 505, data communication means 506.

According to some non-limiting embodiments of the present technology, the processor 501 may be configured to execute specific program instructions the computations as required for the computing environment 500 to function properly or to ensure the functioning of one or more of its components. The processor 501 may further be configured to execute specific machine-readable instructions stored in the at least one non-transitory computer-readable memory 502, for example, those causing the computing environment 500 to execute the training and in-use phases 200, 400 of the present method, as an example.

In some non-limiting embodiments of the present technology, the machine-readable instructions representative of software components of disclosed systems may be implemented using any programming language or scripts, such as C, C++, C#, Java, JavaScript, VBScript, Macromedia Cold Fusion, COBOL, Microsoft Active Server Pages, Assembly, Perl, PHP, AWK, Python, Visual Basic, SQL Stored Procedures, PL/SQL, any UNIX shell scrips or XML. Various algorithms are implemented with any combination of the data structures, objects, processes, procedures, and other software elements.

The at least one non-transitory computer-readable memory 502 may be implemented as RAM and contains the necessary program logic to provide the requisite functionality.

The storage 503 may be implemented as at least one of an HDD drive, an SSD drive, a RAID array, a network storage, a flash memory, an optical drive (such as CD, DVD, MD, Blu-ray), etc. The storage 503 may be configured for long-term storage of various data, e.g., the aforementioned documents with user data sets, databases with the time intervals measured for each user, user IDs, etc.

The input/output interfaces 504 may comprise various interfaces, such as at least one of USB, RS232, RJ45, LPT, COM, HDMI, PS/2, Lightning, FireWire, etc.

The input/output means 505 may include at least one of a keyboard, a joystick, a (touchscreen) display, a projector, a touchpad, a mouse, a trackball, a stylus, speakers, a microphone, and the like. A communication link between each one of the input/output means 505 can be wired (for example, connecting the keyboard via a PS/2 or USB port on the chassis of the desktop PC) or wireless (for example, via a wireless link, e.g., radio link, to the base station which is directly connected to the PC, e.g., to a USB port).

The data communication means 506 may be selected based on a particular implementation of a network, to which the computing environment 500 can have access, and may comprise at least one of: an Ethernet card, a WLAN/Wi-Fi adapter, a Bluetooth adapter, a BLE adapter, an NFC adapter, an IrDa, a RFID adapter, a GSM modem, and the like. As such, the connectivity hardware 504 may be configured for wired and wireless data transmission, via one of a WAN, a PAN, a LAN, an Intranet, the Internet, a WLAN, a WMAN, or a GSM network, as an example.

These and other components of the computing device 500 may be linked together using a common data bus 510.

It should be expressly understood that not all technical effects mentioned herein need to be enjoyed in each and every embodiment of the present technology.

Modifications and improvements to the above-described implementations of the present technology may become apparent to those skilled in the art. The foregoing description is intended to provide certain examples of implementation of the non-limiting embodiments of the present technology rather than to be limiting. The scope of the present technology is therefore intended to be limited solely by the scope of the appended claims.

1. A computer-implemented method for determining a response to cyberthreats, the method comprising:
during a first phase, training, on a server, a neural network to identify false-positive alert messages of information security systems, the training comprising:
generating a cyberthreat database, the generating including acquiring, from a plurality of cyber-intelligence sources, data associated with a plurality of cyberthreats,
the data, for a given cyberthreat of the plurality cyberthreats, including one or more selected from the group consisting of: a type of the given cyberthreat, one or more actor executing the given cyberthreat, means of executing the given cyberthreat, and indicators of compromise associated with the execution of the given cyberthreat;
acquiring a plurality of training alert messages generated by information security systems,
a given training alert message of the plurality of training alert messages being assigned with a respective label representative of whether the given training alert message is one of (i) an alert message that has been generated in response to an actual cyberthreat; and (ii) a false-positive alert message that has been generated without an influence of the actual cyberthreat;
the given training alert message being associated with: (i) internal alert data extracted from the given training alert message; and (ii) host data of the given alert message, including data of a respective host having triggered generation of the given training alert message;
using the internal alert data and the host data associated with the given training alert message to query an Internet graph model to identify additional data for the given training alert message;
using the internal alert data, the host data, and the additional data associated with the given training alert message to query the cyberthreat database to identify enrichment data associated with the given training alert message;
generating a respective vector for the given training alert message using: (i) the internal alert data; (ii) the host data; (iii) the additional data; (iv) the enrichment data associated with the given training alert message; and (iv) the respective label thereof;
feeding the respective vector associated with the given alert message to the neural network, thereby causing the neural network to generate an intermediate prediction of whether a given in-use alert message is false-positive;
optimizing a difference between the intermediate prediction and the respective label associated with the given training alert message, thereby training the neural network to determine whether the given in-use alert message is false-positive;
during a second phase, following the first phase, in response to receiving, by a computing device, communicatively coupled to the server, at least one in-use alert message from a respective information security system:
retrieving, on the computing device, in-use host data and in-use internal alert data associated with the at least one in-use alert message;
using the in-use internal alert data and the in-use host data to query the Internet graph model to identify in-use additional data for the at least one in-use alert message;
using the in-use internal alert data, the in-use host data, and the in-use additional data associated with the at least one in-use alert message to query the cyberthreat database to identify in-use enrichment data associated with the at least one in-use alert message;
generating a respective in-use vector for the at least one in-use alert message using: (i) the in-use internal alert data; (ii) the in-use host data; (iii) the in-use additional data; and (iv) the in-use enrichment data associated with the at least one in-use alert message;
feeding the respective in-use vector to the trained neural network to generate a likelihood value of the at least one in-use alert message being a false-positive alert message;
in response to the likelihood value being lower than a predetermined threshold value, causing the computing device to:
identify the at least one in-use alert message as being generated in response to a respective actual cyberthreat; and
respond to the respective actual cyberthreat; and
in response to the likelihood value being equal to or greater than the predetermined threshold value, causing the computing device to identify the at least one in-use alert message as being a false-positive alert message in the respective information security system.

2. The method of claim 1, wherein the information security systems include one or more selected from the group consisting of:
an Intrusion Detection System (IDS) system;
a Next-Generation Firewall (NGFW) system;
an Endpoint Detection and Response (EDR) system;
a Web Application Firewall (WAF) system;
a Security Information and Event Management (SIEM) system;
an Extended Detection and Response (XDR) system;
an External Attack Surface Management (EASM) system;
an Identity and Access Management (IAM) system;
a Unified Threat Management (UTM) system;
a Cloud Access Security Broker (CASB) system;
a Cloud-Native Application Protection (CNAP) system;
a Cloud Security Posture Management (CSPM) system;
a Cloud Infrastructure Entitlement Management (CIEM) system;
a Cloud Workload Protection Platform (CWPP) system;
a monitoring system; and
a visualization system.

3. The method of claim 1, wherein the causing the computing device to respond to the respective actual cyberthreat includes executing at least one selected from the group consisting of:
causing the computing device to end a process associated with the respective actual cyberthreat;
isolating the computing device;
generating a memory dump of the computing device;
sending a warning notification comprising the at least one selected from the group consisting of in-use alert, the threat data, and the additional data to an operator of the respective information security system;
escalating responding to the respective actual cyberthreat;
restoring an operating system of the computing device to its initial state before the respective actual cyberthreat; and
adding, to a block list, a result of taking a hash function from a malicious file, a domain name, a URI, a URL, and an IP address, associated with the respective actual cyberthreat.

4. The method of claim 3, wherein the sending the warning notification is executed by at least one selected from the group consisting of:
sending an email;
sending a text message;
sending a media messaging service (MMS) message;
sending a push notification;
sending messages in an instant messaging program; and
sending API events.

5. The method of claim 1, wherein the plurality of cyber-intelligence sources includes at least selected from the group consisting of:
open-source intelligence (OSINT);
analyzing closed forums;
structured data flows about malicious software, using Malware feeds;
structured data flows about indicators of compromise, using IoC feeds;
reports of analytical online services;
vulnerability lists, using Common Vulnerability and Exposure (CVE);
lists of intruders and cybercrime groups;
lists of tactics, methodologies, and procedures used by the cybercrime groups and intruders;
program source code repositories;
repositories of exploits;
repositories of templates of malicious websites and phishing kits;
configuration files of the malicious software;
results of reverse engineering of the malicious software;
websites that provide services for exchange of hyperlinks;
websites that provide services for publishing source code texts of the programs;
databases of domains, IP addresses, and links used for phishing and other fraudulent activities;
honeypots;
virtual machines;
scanners of IP addresses;
crawlers; and
telemetry of the information security systems.

6. The method of claim 1, wherein the respective label is further representative of whether the given training alert message includes at least one selected from the group consisting of network interaction data and files data.

7. The method of claim 1, wherein the host data of the respective host associated with the given training alert message comprises at least one selected from the group consisting of:
a name of the respective host within an infrastructure to be protected where the given training alert message has been generated;
user accounts that are present at the respective host;
privilege levels of each of the user accounts;
an organizational and staff structure associated with the name of the respective host;
an organizational and staff structure of each users associated with the respective host;
a local network domain associated with each user that is associated with the respective host;
a technical configuration of the respective host, including one selected from the group consisting of: a server, a desktop computer, a notebook, a tablet, a smartphone, a video camera, a multifunctional device, and a printer;
other alert messages having been generated in the respective host.

8. The method of claim 1, wherein the internal alert data of the given training alert message includes at least one selected from the group consisting of:
a name of a potential cyberthreat associated with the given training alert message;
a hazard level of the potential cyberthreat;
an IP address of a server associated with the potential cyberthreat;
a domain name associated with the potential cyberthreat;
a hyperlink associated with the potential cyberthreat;
a result of taking a hash function from a potentially malicious file associated with the potential cyberthreat; and
a name of a signature that detected the potential cyberthreat.

9. The method of claim 1, wherein the additional data comprises at least one selected from the group consisting of:
a name of an ownership company of an IP address of a server associated with a potential cyberthreat having triggered the given training alert message;
a hosting provider of the IP address;
a validity period of the IP address;
a list of ports that are open at this IP address;
a list of network services launched at this IP address;
a hash function of a sum of configurations of each of the list of network services;
types, names, and versions of programs installed on the computing device located at the IP address;
a tag that is a name of a cybercrime group or a malicious software;
a name of an ownership company of a domain associated with a potential cyberthreat;
a domain registrar of the domain;
a domain validity period of the domain;
a status of an SSL-or a TLS-certificate of the domain;
parameters of the SSL-or TLS-certificate, including encryption algorithms that may be used by a server, where the SSL-or TSL certificates are installed; and
a validity period of the SSL-or TLS-certificate.

10. The method of claim 9, further comprising filtering the additional data by dates associated with the given training alert message.

11. The method of claim 1, wherein the enrichment data comprises at least one selected from the group consisting of:
a name of malicious software associated with the given training alert message;
a name of a cybercrime group associated with the given training alert message;
a vulnerability designation value according to a Common Vulnerability and Exposure (CVE) system, associated with the given training alert message;
a compromise indicator associated with the given training alert message;
an IP address associated with the given training alert message; and
a result of taking a hash function from a malicious file associated with the given training alert message.

12. The method of claim 1, wherein the trained neural network is configured to identify less than 1% of false-positive alert messages on a random sample of alert messages that were not used for training the neural network.

13. The method of claim 1, wherein:
the neural network comprises three neural networks; and
training the neural network comprises training a first neural network using those of the plurality of training alert messages, including network interaction data; training a second neural network using those of the plurality of training alert messages, including files data of; and training a third neural network using the host data associated with the plurality of training alert messages.

14. The method of claim 13, wherein the applying the neural network comprises:
applying the first neural network to generate a first likelihood value of the at least one in-use alert message being false-positive;
applying the second neural network to generate a second likelihood value of the at least one in-use alert message being false-positive; and
applying the third neural network to generate a third likelihood value of the at least one in-use alert message being false-positive.

15. The method of claim 14, further comprising determining a final likelihood value of the at least one in-use alert message being false-positive by determining a geometric mean of the first, second, and third likelihood values.

16. A server for determining a response to cyberthreats, the server comprising at least one processor and a non-transitory computer-readable memory storing executable instructions, which, when executed by the at least one processor, cause the system to:
during a first phase, train a neural network to identify false-positive alert messages of information security systems, by:
generating a cyberthreat database, the generating including acquiring, from a plurality of cyber-intelligence sources, data associated with a plurality of cyberthreats,
the data, for a given cyberthreat of the plurality cyberthreats, including one or more selected from the group consisting of: a type of the given cyberthreat, one or more actor executing the given cyberthreat, means of executing the given cyberthreat, and indicators of compromise associated with the execution of the given cyberthreat;
acquiring a plurality of training alert messages generated by information security systems,
a given training alert message of the plurality of training alert messages being assigned with a respective label representative of whether the given training alert message is one of (i) an alert message that has been generated in response to an actual cyberthreat; and (ii) a false-positive alert message that has been generated without an influence of the actual cyberthreat;
the given training alert message being associated with: (i) internal alert data extracted from the given training alert message; and (ii) host data of the given alert message, including data of a respective host having triggered generation of the given training alert message;
using the internal alert data and the host data associated with the given training alert message to query an Internet graph model to identify additional data for the given training alert message;
using the internal alert data, the host data, and the additional data associated with the given training alert message to query the cyberthreat database to identify enrichment data associated with the given training alert message;
generating a respective vector for the given training alert message using: (i) the internal alert data; (ii) the host data; (iii) the additional data; (iv) the enrichment data associated with the given training alert message; and (iv) the respective label thereof;
feeding the respective vector associated with the given alert message to the neural network, thereby causing the neural network to generate an intermediate prediction of whether a given in-use alert message is false-positive;
optimizing a difference between the intermediate prediction and the respective label associated with the given training alert message, thereby training the neural network to determine whether the given in-use alert message is false-positive;
during a second phase, following the first phase, in response to receiving, by a computing device, communicatively coupled to the at least one processor, at least one in-use alert message from a respective information security system, execute:
retrieving, on the computing device, in-use host data and in-use internal alert data associated with the at least one in-use alert message;
using the in-use internal alert data and the in-use host data to query the Internet graph model to identify in-use additional data for the at least one in-use alert message;
using the in-use internal alert data, the in-use host data, and the in-use additional data associated with the at least one in-use alert message to query the cyberthreat database to identify in-use enrichment data associated with the at least one in-use alert message;
generating a respective in-use vector for the at least one in-use alert message using: (i) the in-use internal alert data; (ii) the in-use host data; (iii) the in-use additional data; and (iv) the in-use enrichment data associated with the at least one in-use alert message;
feeding the respective in-use vector to the trained neural network to generate a likelihood value of the at least one in-use alert message being a false-positive alert message;
in response to the likelihood value being lower than a predetermined threshold value, causing the computing device to:
identify the at least one in-use alert message as being generated in response to a respective actual cyberthreat; and
respond to the respective actual cyberthreat; and
in response to the likelihood value being equal to or greater than the predetermined threshold value, causing the computing device to identify the at least one in-use alert message as being a false-positive alert message in the respective information security system.

17. The server of claim 16, wherein at least one of the Internet graph model, the cyberthreat database, and the neural network are stored in memories of different servers communicatively coupled, over a communication network, to the at least one processor of the server.
